(19) United States
(12) Patent Application Publication
(10) Pub. No.: US 2009/0150880 A1
(43) Pub. Date: Jun. 11, 2009

(54) PRINTER DRIVER INSTALLING METHOD, RECORDABLE MEDIUM RECORDED WITH PROGRAM EXECUTING THE INSTALLING METHOD, IMAGE FORMING APPARATUS AND HOST APPARATUS THEREOF

(75) Inventors: Seong-kyoo PARK, Hwaseong-si (KR); Hyung-ho Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/271,114

(22) Filed: Nov. 14, 2008

(30) Foreign Application Priority Data
Dec. 5, 2007 (KR) 2007-125589

(51) Int. Cl. G06F 9/445; G06F 15/16

(52) U.S. Cl. 717/174; 709/226

(57) ABSTRACT

A printer driver installing method installs a driver program which corresponds to an image forming apparatus in a host apparatus which is connected to the image forming apparatus, and includes selecting installation of the driver program, controlling the image forming apparatus to receive an installer information, authorizing by using the received installer information, and installing the driver program in the host apparatus if the installer information is authorized.

### CROSS-REFERENCE TO RELATED APPLICATIONS

This application claims priority under 35 U.S.C. §119(a) from Korean Patent Application No. 10-2007-0125589, filed on Dec. 5, 2007 in the Korean Intellectual Property Office, the disclosure of which is incorporated herein by reference in its entirety.

### BACKGROUND OF THE INVENTION

1. Field of the Invention

The present general inventive concept relates to a printer driver installing method, a recordable medium recorded with a program to execute the installing method and an image forming system thereof, and more particularly, to a printer driver installing method, a recordable medium recorded with a program executing the installing method, an image apparatus and a host apparatus thereof having an improved a security function.

2. Description of the Related Art

An image forming apparatus scans an image of a document or receives printing data to form an image on a printing medium, and includes an electronic copier, a multifunction device, a laser printer, an inkjet printer, etc.

The image forming apparatus is connected to a host apparatus by means of a network, or a parallel port, a universal serial bus (USB) port, etc., and the host apparatus is installed with a printer driver program necessary to drive the image forming apparatus (hereinafter, referred to ‘printer driver’). The printer driver converts original data generated through an application of the host apparatus into printing data which is capable of being interpreted by the image forming apparatus.

However, the printer driver can be installed by any one of users in the host apparatus without restriction. Especially, if the image forming apparatus is connected to a network, a printing work can be performed just by installing the printer driver in any host apparatus connected to the network, thereby deteriorating security.

### SUMMARY OF THE INVENTION

The present general inventive concept provides a printer driver installing method, a recordable medium recorded with a program to execute the installing method, an image forming apparatus and a host apparatus thereof having an improved security function.

Additional aspects of the present general inventive concept will be set forth in part in the description which follows and, in part, will be obvious from the description, or may be learned by practice of the present general inventive concept.

The foregoing and/or other aspects of the present general inventive concept can be achieved by providing a printer driver installing method which installs a driver program which corresponds to an image forming apparatus in a host apparatus which is connected to the image forming apparatus, the printer driver installing method comprising selecting installation of the driver program, controlling the image forming apparatus to receive installer information, authorizing by using the received installer information, and installing the driver program in the host apparatus if the installer information is authorized.

The authorizing may comprise using at least one of authorization information which is previously stored in the image forming apparatus, and authorization information which is received from an external apparatus which is connected with the image forming apparatus.

The authorizing may further comprise comparing the received installer information and the authorization information.

The printer driver installing method may further comprise transmitting an installer authorization result to the host apparatus.

The printer driver installing method may further comprise not installing the driver program in the host apparatus if the installer information is not authorized.

The printer driver installing method may further comprise displaying an installer authorization result to a user.

The printer driver installing method may further comprise inputting the installer information in the host apparatus, and transmitting the inputted installer information to the image forming apparatus.

The printer driver installing method may further comprise displaying information about the image forming apparatus which is connected to the host apparatus.

The printer driver installing method may further comprise determining whether the installer information is inputted from a user, and transmitting at least one of an internet protocol (IP) address, a computer name and a media access control (MAC) address of the host apparatus to the image forming apparatus if there is no input.

The printer driver installing method may further comprise storing at least one of an internet protocol (IP) address, a computer name and a media access control (MAC) address of the host apparatus in at least one of the image forming apparatus and an external apparatus to which the image forming apparatus is connected if the driver program is completely installed in the host apparatus.

The foregoing and/or other aspects of the present invention can be achieved by providing a recordable medium recorded with a program to execute a printer driver installing method which installs a driver program which corresponds to an image forming apparatus in a host apparatus which is connected to the image forming apparatus, the printing driver installing method comprising selecting installation of the driver program, controlling the image forming apparatus to receive installer information, authorizing by using the received installer information, and installing the driver program in the host apparatus if the installer information is authorized.

The foregoing and/or other aspects of the present invention can be achieved by providing an image forming apparatus which is connected to a host apparatus, comprising an interface unit which communicates with the host apparatus, an installer authorizing unit which authorizes whether an installer who installs a driver program in the host apparatus is an authorized installer, and a control unit which controls the installer authorizing unit and the interface unit to perform an installer authorization and transmit an authorization result to the host apparatus if the installer authorization is requested from the host apparatus.

The image forming apparatus may further comprise a storing unit which stores information related with the authorized installer.

The control unit may control the interface unit to receive information related with the authorized installer from a server which is connected with the image forming apparatus if the installer authorization is requested.

The foregoing and/or other aspects of the present invention can also be achieved by providing a host apparatus which is connected to an image forming apparatus, the host apparatus comprising a host control unit configured to allow and prevent installation of a driver program which corresponds to the image forming apparatus depending on the received authorization result.

The host apparatus may further include a host interface unit to communicate with the image forming apparatus through a network to receive the authorization result from the image forming apparatus.

The host apparatus may further include a host interface unit to communicate with a plurality of external apparatuses including the image forming apparatus, wherein the host interface unit receives the authorization result from the image forming apparatus.

The host apparatus may further include a host interface unit to communicate with a plurality of external apparatuses including the image forming apparatus and a server through a network, and the host interface unit may receive the authorization result according to a communication with the image forming apparatus and the server.

The host control unit may generate a request signal to request the image forming apparatus to authorize the installation of the driver program.

The host control unit may install a driver of the driver program according to the received authorization result, and the driver may generate data such that the image forming apparatus prints an image according to the data generated from the driver.

The host control unit may not install the driver program according to an internally generated authorization result.

The host control unit may not install the driver program according to the authorization result from another external apparatus other than the image forming apparatus.

The foregoing and/or other aspects of the present invention can also be achieved by providing an image forming system including an image forming apparatus to generate an authorization result regarding authorization on a driver program, and a host apparatus to install a driver program to correspond to the image forming apparatus according to the authorization result of the image forming apparatus.

The foregoing and/or other aspects of the present invention can also be achieved by providing an image forming apparatus including a control unit configured to output an authorization result to an external host apparatus such that the external host apparatus allows installation of a driver program according to the authorization result.

### BRIEF DESCRIPTION OF THE DRAWINGS

These and/or other aspects of the present general inventive concept will become apparent and more readily appreciated from the following description of the exemplary embodiments, taken in conjunction with the accompanying drawings, in which:

FIG. 1 is a block diagram illustrating an image forming system according to an exemplary embodiment of the present general inventive concept;

FIG. 2 illustrates an example of an information data base (DB) about an authorized installer;

FIG. 3 is a flowchart illustrating a driving driver installing method according to an exemplary embodiment of the present general inventive concept;

FIGS. 4A and 4B are flowcharts illustrating a driving driver installing method according to an exemplary embodiment of the present general inventive concept; and

FIGS. 5A and 5B are flowcharts illustrating a driving driver installing method according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The exemplary embodiments are described below so as to explain the present general inventive concept by referring to the figures.

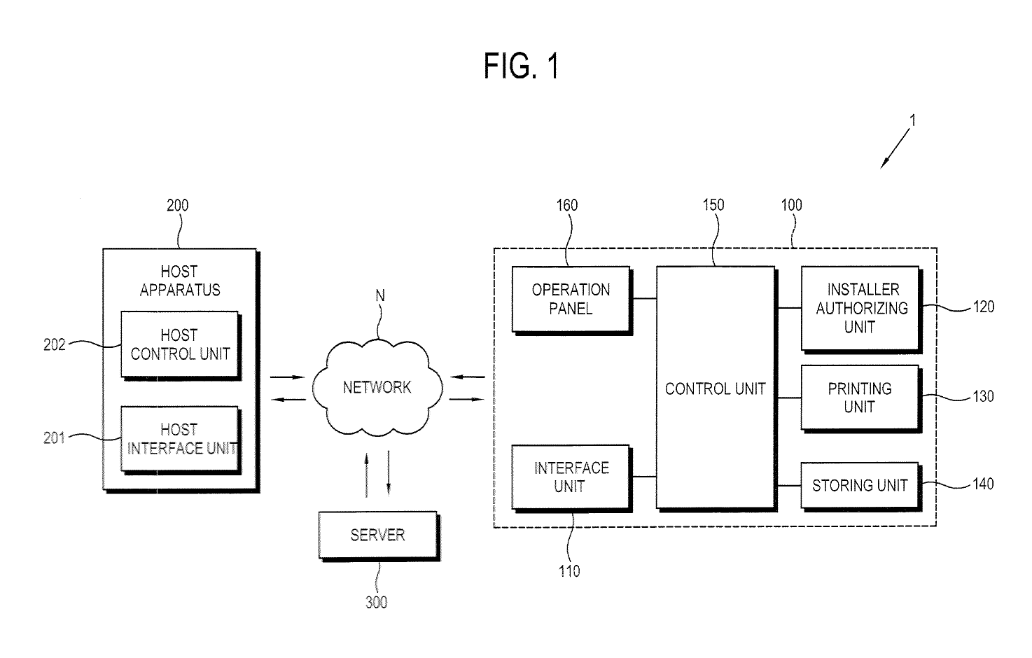

Referring to FIG. 1, an image forming system 1 according to an exemplary embodiment of the present general inventive concept includes an image forming apparatus 100 and a host apparatus 200.

The image forming apparatus 100 includes an interface unit 110 to communicate with the host apparatus 200 and/or a server 300 through a network N, an installer authorizing unit 120 using installer information received through the interface unit 110 to perform an installer authorization, and a control unit 150 to control the interface unit 110 and the installer authorizing unit 120.

The host apparatus 200, for example, is installed with an operating system (OS) such as WINDOWS of MICROSOFT, and is provided to execute a driving driver installing file of the image forming apparatus 100 which is stored in a storing medium such as a floppy disk, a compact disk (CD), a hard disk, etc. That is, the host apparatus 200 includes an input unit (not illustrated), such as a keyboard, a mouse, etc., to apply an installation order of the driving driver, a display unit (not illustrated), such as a liquid crystal display (LCD) monitor, a cathode ray tube (CRT) monitor, etc., to display the installing file, a storage device (not illustrated) such as a floppy disk drive, a compact disk read only memory (CD ROM) drive, etc., to read information stored in the storing medium, a host interface unit 201 to communicate with the image forming apparatus 100 and the server 300 through a network N, a host control unit (central processing unit (CPU) 202, and a memory (not illustrated) to store data thereof.

Here, the information about an installer to install the printer driver may be inputted through the input unit of the host apparatus 200. If an operation panel 160 including an input key (not illustrated) and a display panel (not illustrated) is provided to the image forming apparatus 100, the installer information may be inputted to the image forming apparatus 100 through the operation panel 160. The image forming apparatus 100 may receive an installer authorization request from the host apparatus 200, and the installer information necessary to authorize the authorization may be received through the operation panel 160 of the image forming apparatus 100.

Here, the installer information may be at least one of a computer name of the host apparatus 200, an internet protocol (IP) address, a media access control (MAC) address of a host interface unit (not shown), a user identification and a password. Alternatively, the installer information may include other various types of information which are capable of being used to the installer authorization in addition to the above-described information.

The host apparatus 200 may further include a host interface unit such as a network interface card (NIC) (not illustrated) to be connected to the image forming apparatus 100 through the network N. As necessary, the host interface unit may be provided as a parallel port or a universal serial bus (USB) port.

The host apparatus 200 may be provided as a portable computer such as a laptop computer, a personal digital assistant (PDA), a portable multimedia player (PMP), etc., which is capable of being connected with the image forming apparatus 100 as well as a desktop personal computer (PC).

The host control unit of the host apparatus 200 transmits a message to request the installer authorization to the image forming apparatus 100 through the host interface unit if the installer authorization is necessary to install the driving driver. This installer authorizing process may be performed when the driving driver installing file is executed in the host apparatus 200, and the installer authorizing process may be performed as an independent installer authorizing process separated from the executing of the driving driver installing file as necessary. This will be described in detail in the printer driver installing method described below.

Also, the host control unit allows and disallows (prevents) the installation of the printer driver depending on result of the installer authorization received from the image forming apparatus 100.

As illustrated in FIG. 1, the image forming apparatus 100 includes the interface unit 110, the installer authorizing unit 120 and the control unit 150 to perform the installer authorizing process.

The interface unit 110 enables communication between the host apparatus 200 and the image forming apparatus 100. The interface unit 110 may be provided as a network interface card (NIC) so that the host apparatus 200 and the image forming apparatus 100 can be connected with each other through the network N. As necessary, the interface unit 110 may be provided as a universal serial bus (USB) port or a parallel port.

The installer authorizing unit 120 compares the installer information received through the interface unit 110 or inputted through the operation panel 160 with installer information which is previously stored and authorized to perform the installer authorizing operation. For example, if installer information of a user identification ‘David’ and a password ‘1234’ is inputted, ‘authorization success’ may be outputted if there is the inputted installer information in an authorized installer information database (DB), and ‘authorization fail’ may be outputted if there is not. As necessary, the installer authorizing unit 120 may be provided to be integrated to the control unit 150.

The image forming apparatus 100 of the image forming system 1 according to the present exemplary embodiment may further include a storing unit 140. The storing unit 140 may be provided as a flash memory, a hard disk, etc., as long as it can store the authorized installer information. It is preferable but not necessary that the storing unit 140 is provided to store the authorized installer information although power of the image forming apparatus 100 is turned off.

The authorized installer information may be stored in the storing unit 140. The authorized installer information data base (DB) may be provided by inputting information about a user allowed to install the printer driver by an administrator (that is, an authorized installer) through the operation panel 160 and storing the information.

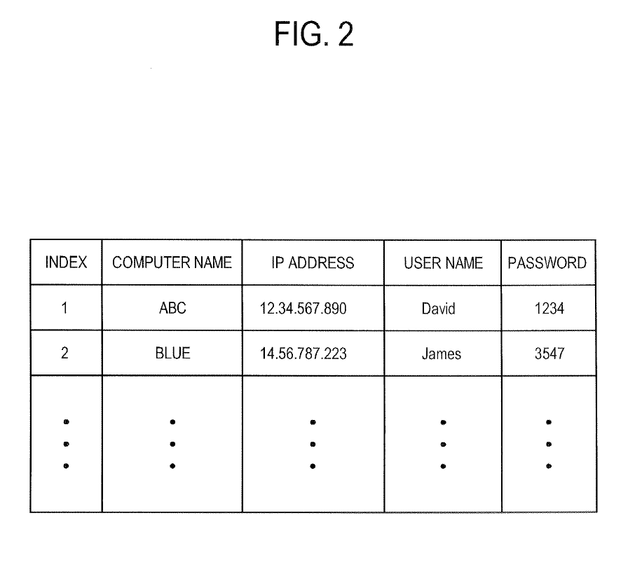

FIG. 2 illustrates an example of the information data base (DB) about the authorized installer. As illustrated in FIG. 2, each of authorized installer information may include data of ‘computer name’ and ‘IP address’ of the host apparatus, ‘user name’ and ‘password’.

If the installer authorization is requested from the host apparatus 200 through the interface unit 110, the control unit 150 controls the installer authorizing unit 120 to perform the installer authorization, and transmits an authorization result (authorization success or authorization fail) to the host apparatus 200 through the interface unit 110.

The host apparatus 200 receives the authorization result to allow installation of the printer driver if the authorization succeeds, and to disallow or prevents the installation if the authorization does not succeed. In more detail, if the installer authorization operation is performed by the image forming apparatus 100 when the installing file of the printer driver is executed, the installation operation of the printer driver may be continued or ended to correspond to the authorization result of the authorization success and fail.

As necessary, the installer authorization operation of the image forming apparatus 100 may not be performed during the installation process of the printer driver. For example, an installer authorization program to independently perform only the installer authorization operation is supplied to a user together with the printer driver installing file so that the user can execute the installer authorization program in advance before installing the printer driver. That is, if the user executes the installer authorization program in the host apparatus 200, the installer authorization operation of the image forming apparatus 100 is performed so that the authorization result can be stored in a memory or a hard disk of the host apparatus 200, or the storing unit 140 of the image forming apparatus 100. Then, the authorization result stored during the installing process of the printer driver may be confirmed, and the installation of the printer driver may be continued or ended according thereto.

Accordingly, the printer driver can be prevented from being installed by an unauthorized user, thereby improving a security function of the image forming apparatus 100.

Also, the installer authorization operation is performed by the image forming apparatus 100 instead of the host apparatus 200, thereby reducing a load applied to the host apparatus 200.

Also, the authorized installer information is stored in the image forming apparatus 100 or the server 300 instead of the host apparatus 200 which is apt to be hacked, thereby further improving the security function. Also, the authorized installer information is stored in the image forming apparatus 100 or the server 300, thereby reducing possibility of deletion or falsification of the information due to carelessness of the user to improve an efficient management.

The image forming apparatus 100 may further include a printing unit 130 to form an image on a printing medium. As necessary, the printing unit 130 may be replaced by a scanning unit (not illustrated) to scan an image of a document.

The printing unit 130 may be provided as at least one of conventional image forming types such as an inkjet type, a heat transferring type, an electrophotographic type, etc.

The image forming system 1 according to the present exemplary embodiment may further include the server 300. The server 300 is capable of communicating with the image forming apparatus 100 through the network N. The server 300 is an external apparatus connected with the image forming apparatus 100. Here, the external apparatus is an apparatus provided with the authorized installer information DB to supply the authorized installer information to the image forming apparatus 100, and may be variously changed irrespectively of the name of the server 300. The authorized installer information DB may be provided to the server 300 instead of being stored in the storing unit 140 of the image forming apparatus 100. In this case, the storing unit 140 of the image forming apparatus 100 may be not used to store the authorized installer information DB.

The control unit 150 of the image forming apparatus 100 controls the interface unit 110 and the installer authorizing unit 120 to receive the authorized installer information from the server 300 to perform the installer authorization operation if the installer authorization is requested to install the driving driver from the host apparatus 200. Also, after the authorization operation is completed, the control unit 150 transmits the authorization result thereof to the host apparatus 200.

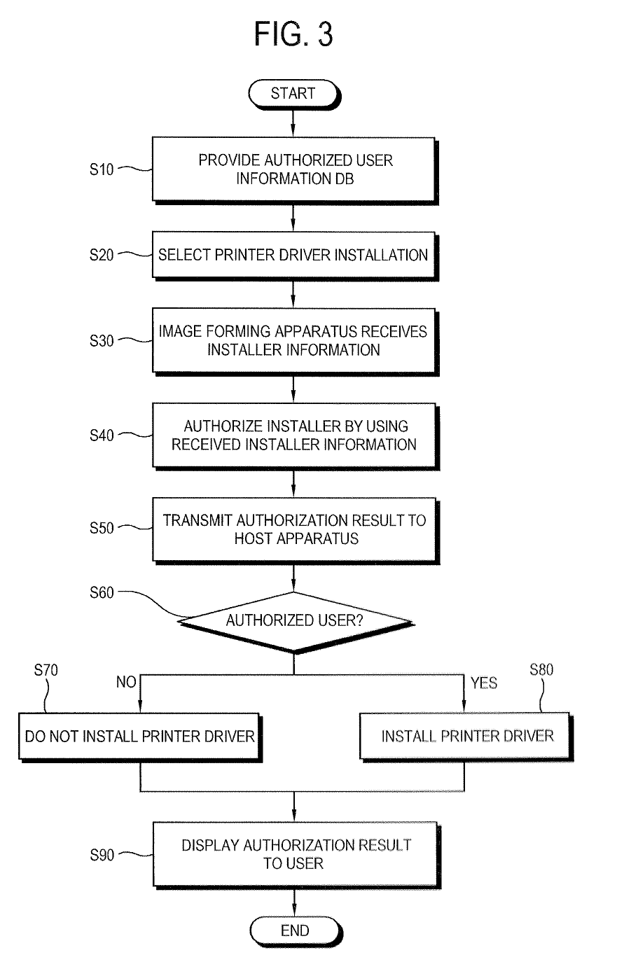

Hereinafter, a printer driver installing method according to an exemplary embodiment of the present general inventive concept to install a printer driver corresponding to an image forming apparatus 100 to a host apparatus 200 will be described by referring to FIGS. 3 to 5B.

As illustrated in FIG. 3, the printer driver installing method according to the present general inventive concept provides an authorized installer information DB at operation S10. The authorized installer information DB is preferably but not necessarily provided to the image forming apparatus 100 as illustrated in FIG. 3 or a server 300 from a point of security and management.

Then, a printer driver installation is selected at operation S20.

Then, the image forming apparatus 100 receives installer information through an interface unit 110 or an operation panel 160 at operation S30.

Then, the installer authorization is performed by using the received installer information at operation S40.

Then, an authorization result is transmitted to the host apparatus 200 at operation S50.

The received authorization result is confirmed, and the printer driver is installed in the host apparatus 200 at operation S80 in a case of an authorized installer, that is, if the installer information is authorized at operation S60, and the printer driver is not installed at operation S70 if the installation is not authorized at operation S60.

Then, the authorization result is displayed to a user at operation S90. As necessary, the operation S90 may be performed only if the installer authorization fails. However, it is possible that the operation S90 may be performed when the installer authorization succeeds. Accordingly, an installer can know that the installer oneself is not authorized, and may request an appropriate management to a printer administrator. As necessary, the operation S90 may be omitted.

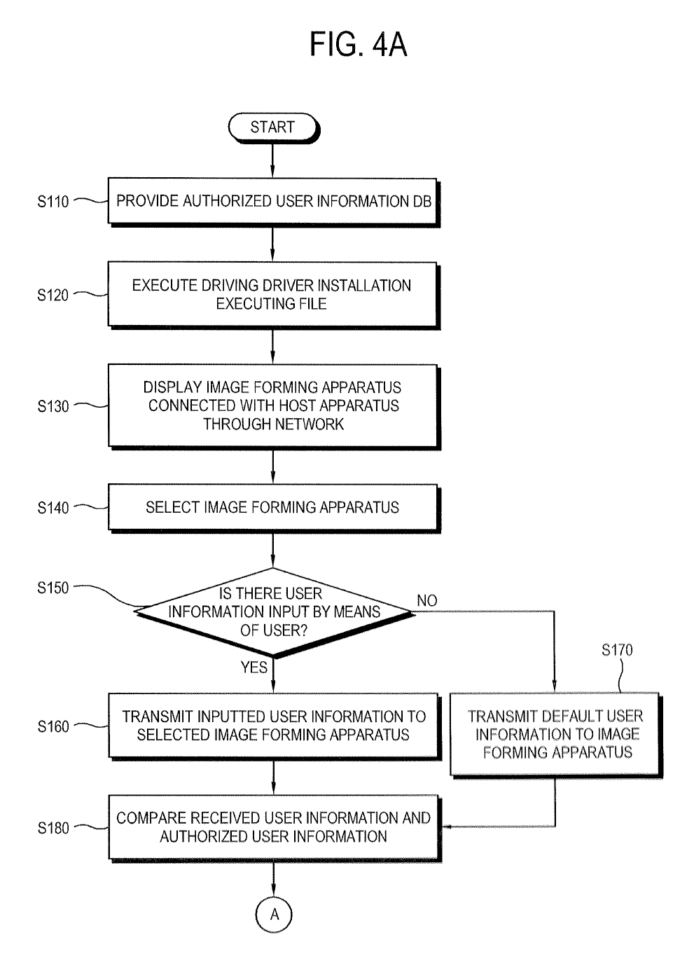

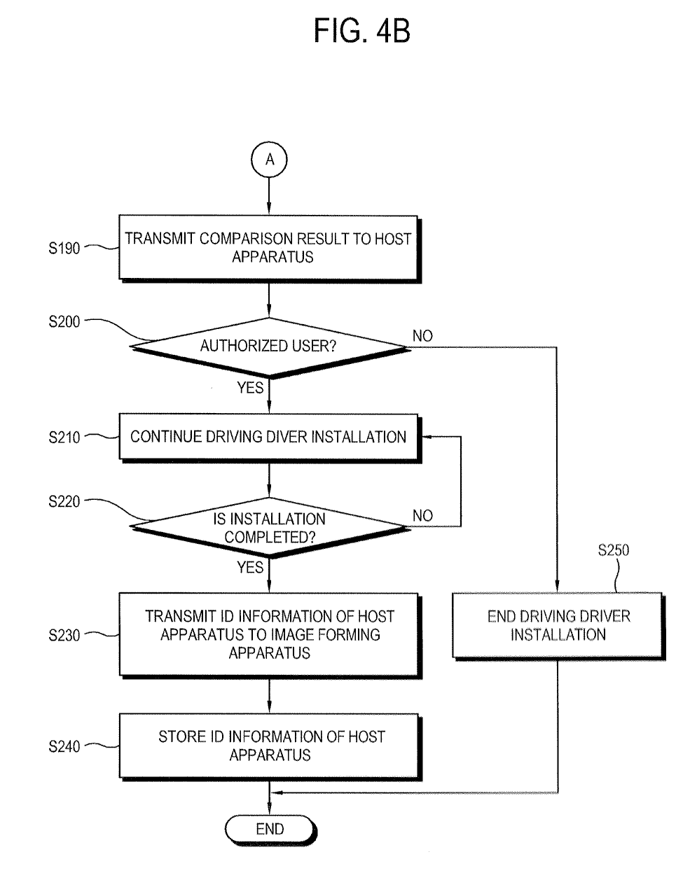

Hereinafter, a printer driver installing method according to an exemplary embodiment of the present general inventive concept will be described more in detail by referring to FIGS. 4A and 4B. An operation S110 of providing authorized installer information DB is similar to operation S10 of the printer driver installing method of FIG. 3.

A user executes an executing file to install a printer driver in a host apparatus 200 at operation S120. A display unit (not illustrated) of the host apparatus 200 displays an image forming apparatus 100 connected with the host apparatus 200 through a network, and the user selects the image forming apparatus 100 which is to be a driving target and a subject of an installer authorization of the driving driver at operation S140. Operations S130 and S140 may be unnecessary if a specific image forming apparatus is determined to be automatically selected, or if the image forming apparatus 100 connected through the network is only one.

Then, it is determined whether there is an installer information input by a user at operation S150. It is determined whether there is a direct input by the user through the input unit (not illustrated) of the host apparatus 200 or an operation panel 160 of the image forming apparatus 100 or not. As necessary, the user may be guided to input specific information of the installer information, for example, user identification and password, a user internet protocol address, etc., before the operation S150 through a graphic user interface (GUI).

If there is no input by the user, default installer information is transmitted to the image forming apparatus 100 at operation S170. Here, the default installer information may include at least one of a computer name, an internet protocol (IP) address and a media access control (MAC) address exampled as the installer information. Since the computer name, the IP address and the MAC address are previously determined, these are capable of being transmitted to the image forming apparatus 100 as the default installer information although there is no user input. The computer name, the IP address and the MAC address are just example, and alternatively, the default installer information may include various types of other information. If there is an installer information input by the user, the input installer information is transmitted to the image forming apparatus 100 at operation S160.

Then, the received installer information and the authorized installer information are compared to perform an installer authorization at operation S180. Here, the installer authorization may be determined as successful if all installer information illustrated in FIG. 2 match, or the installer authorization may be determined as successful” if a part of the installer information match.

For example, if four types of information of the computer name, the IP address, the user name and the password match, the installer authorization may be determined to succeed, or if a part thereof matches, the installer authorization may be determined to succeed. For example, if the computer name and the IP address match, the installer authorization may be determined to succeed, or if the user identification and the password accord, the installer authorization may be determined to succeed.

Then, the image forming apparatus 100 transmits a comparison result, that is, an authorization result to the host apparatus 200 at operation S190.

Then, the host apparatus 200 receives and confirms the authorization result, and continues a printer driver installation in a case of an authorized user at operations S200 and S210.

Then, if the printer driver installation is completed, the ID information of the host apparatus 200 is transmitted to the image forming apparatus 100 at operations S220 and S230. Here, the ID information of the host apparatus 200 is for identifying the host apparatus 200, and may include at least one of a computer name, an IP address and an MAC address. If necessary, the ID information of the host apparatus 200 may be replaced by the installer information in the operations S160 and S170, and in this case, the operation S230 may be not performed.

A control unit 150 of the image forming apparatus 100 stores the ID information of the host apparatus 200 transmitted from the host apparatus 200 in a server 300 or a storing unit 140 at operation S240. Accordingly, an administrator can confirm that the printer driver is installed in a corresponding host apparatus 200 so that management thereof can become convenient. If necessary, a user ID is stored together with the ID information of the host apparatus 200 to enable the administrator to know who has attempted installing the printer driver.

The host apparatus 200 receives and confirms the authorization result to end the printer driver installation if it is not an authorized user at operation S200 and S250. If the installer authorization fails, storing the installer information which the control unit 150 of the image forming apparatus 100 receives through the operations S160 and S170 in the server 300 or the storing unit 140 may be further included. Accordingly, the administrator can confirm who has failed to the installer authorization, or in what host apparatus 200 fails the installer authorization.

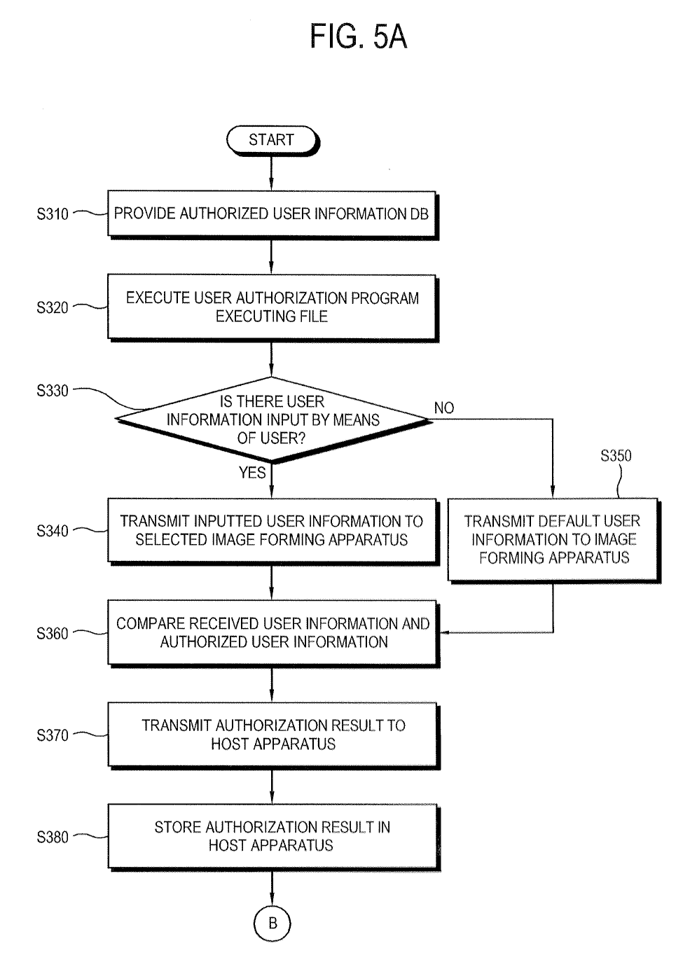

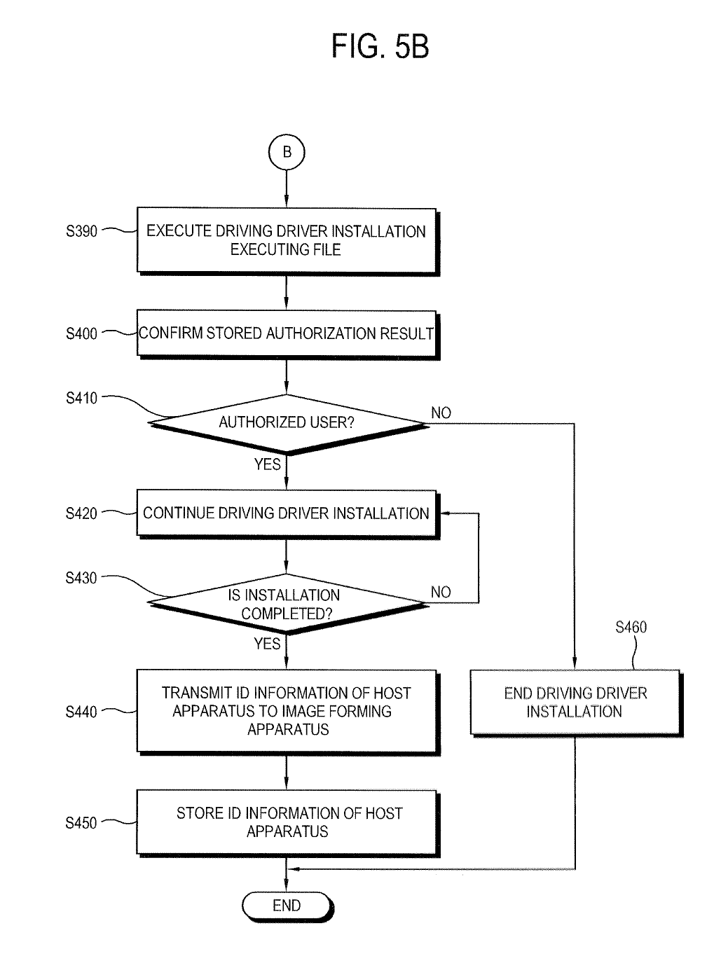

Hereinafter, a driving driver installing method according to an exemplary embodiment of the present general inventive concept will be described by referring to FIGS. 5A and 5B.

An administrator provides an authorized installer information DB in a server 300 or a storing unit 140 of an image forming apparatus 100 at operation S310. This operation may be similar to the operations S10 and S110 of FIGS. 3 and 4A.

Then, a user executes an executing file of an installer authorization program in a host apparatus 200 at operation S320.

Operations S330 to S370 may respectively correspond to the operations S150 to S190 of FIGS. 4A and 4B.

The host apparatus 200 stores an installer authorization result transmitted from the image forming apparatus 100 in a storing unit such as a hard disk (not illustrated) at operation S380.

Then, if the user executes an executing file for installing a printer driver necessary to drive the image forming apparatus 100 at operation S390, the stored authorized result is confirmed at operation S400.

In the confirmed result, if the stored authorization result is confirmed to succeed, that is, in case of an authorized installer, the printer driver installation is continued to be completed at operations S410, S420 and S430. Operations S440 and S450 may be the same as the operations S230 and S240 of FIG. 4B.

In the confirmed result, if the stored authorization result is confirmed to fail, that is, in case of an unauthorized installer, the printer driver installation is completed at operation S460.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, a printer driver installing method, a recordable medium, an image forming apparatus and a host apparatus according to the present general inventive concept have the following effects.

First, a printer driver can be prevented from being installed by an unauthorized user, thereby improving a security function.

Second, an installer authorization operation is allowed to be performed in an image forming apparatus instead of a host apparatus, thereby reducing a load applied to the host apparatus.

Third, information about an authorized installer is provided to an image forming apparatus or a server instead of a host apparatus which is apt to be hacked, thereby reinforcing a security function, reducing possibility of deletion or falsification of the information due to carelessness of a user to improve an efficient management.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A printer driver installing method to install a driver program corresponding to an image forming apparatus in a host apparatus which is connected to the image forming apparatus, the printer driver installing method comprising:
selecting installation of the driver program;
controlling the image forming apparatus to receive installer information;
authorizing according to the received installer information; and
installing the driver program in the host apparatus if the installer information is authorized.

2. The printer driver installing method of claim 1, wherein the authorizing comprises using at least one of authorization information which is previously stored in the image forming apparatus, and authorization information which is received from an external apparatus which is connected with the image forming apparatus.

3. The printer driver installing method of claim 2, wherein the authorizing further comprises comparing the received installer information and the authorization information.

4. The printer driver installing method of claim 1, further comprising:
transmitting an installer authorization result to the host apparatus.

5. The printer driver installing method of claim 1, further comprising:
not installing the driver program in the host apparatus if the installer information is not authorized.

6. The printer driver installing method of claim 1, further comprising:
displaying an installer authorization result to a user.

7. The printer driver installing method of claim 1, further comprising:
inputting the installer information in the host apparatus, and
transmitting the inputted installer information to the image forming apparatus.

8. The printer driver installing method of claim 1, further comprising:
displaying information about the image forming apparatus which is connected to the host apparatus.

9. The printer driver installing method of claim 1, further comprising:
determining whether the installer information is inputted from a user, and
transmitting at least one of an internet protocol (IP) address, a computer name and a media access control (MAC) address of the host apparatus to the image forming apparatus if there is no input.

10. The printer driver installing method of claim 1, further comprising:
storing at least one of an internet protocol (IP) address, a computer name and a media access control (MAC) address of the host apparatus in at least one of the image forming apparatus and an external apparatus to which the image forming apparatus is connected if the driver program is completely installed in the host apparatus.

11. A recordable medium recorded with a program to execute a printer driver installing method which installs a driver program which corresponds to an image forming apparatus in a host apparatus which is connected to the image forming apparatus, the printing driver installing method comprising:
selecting installation of the driver program;
controlling the image forming apparatus to receive installer information;
authorizing according to the received installer information; and
installing the driver program in the host apparatus if the installer information is authorized.

12. An image forming apparatus which is connected to a host apparatus, comprising:
an interface unit to communicate with the host apparatus;
an installer authorizing unit to authorize whether an installer who installs a driver program in the host apparatus is an authorized installer; and
a control unit to control the installer authorizing unit and the interface unit to perform an installer authorization and to transmit an authorization result to the host apparatus if the installer authorization is requested from the host apparatus.

13. The image forming apparatus of claim 12, further comprising:
a storing unit which stores information related with the authorized installer.

14. The image forming apparatus of claim 12, wherein the control unit controls the interface unit to receive information related with the authorized installer from a server which is connected with the image forming apparatus if the installer authorization is requested.

15. A host apparatus which is connected to an image forming apparatus, the host apparatus comprising:
a host control unit configured to allow and prevent installation of a driver program which corresponds to an image forming apparatus, according to an authorization result received from the image forming apparatus; and
a host interface unit to communicate with the image forming apparatus through a network to receive the authorization result from the image forming apparatus.

16. The host apparatus of claim 15, wherein the host control unit generates a request signal to request the image forming apparatus to authorize the installation of the driver program.

17. The host apparatus of claim 15, wherein the host control unit installs a driver of the driver program according to the received authorization result, and the driver generates data such that the image forming apparatus prints an image according to the data generated from the driver.

18. The host apparatus of claim 15, wherein the host control unit does not install the driver program according to an internally generated authorization result.

19. The host apparatus of claim 15, wherein the host control unit does not install the driver program according to the authorization result from another external apparatus other than the image forming apparatus.

20. An image forming apparatus comprising:
a control unit configured to output an authorization result to an external host apparatus such that the external host apparatus allows installation of a driver program according to the authorization result.
